(19) United States
(12) Patent Application Publication
(10) Pub. No.: US 2012/0267895 A1
(43) Pub. Date: Oct. 25, 2012

(54) POWER GENERATOR

(75) Inventors: Drew Blaxland, Singapore (SG); John Keir, Singapore (SG)

(73) Assignee: ATLANTIS RESOURCES CORPORATION PTE LIMITED, Singapore (SG)

(21) Appl. No.: 13/394,673

(22) PCT Filed: Sep. 8, 2010
(86) PCT No.: PCT/AU2010/001161

§ 371 Date: May 23, 2012

(30) Foreign Application Priority Data
Sep. 8, 2009 (AU) 2009904330

(51) Int. Cl. F03B 13/10

(52) U.S. Cl. 290/54

(57) ABSTRACT

A power generation apparatus is described. The apparatus includes a rotor adapted for rotation about a rotation axis, the rotor comprising a blade assembly including a plurality of blades operatively mounted to the rotor and extending therefrom from and adapted to be acted upon by flowing water from a direction generally perpendicular to the rotation axis to rotate the rotor; wherein the rotor includes an integral rotor body adapted to rotate about a stator body disposed internally relative thereto to generate usable power.

### TECHNICAL FIELD

The present invention relates generally to underwater power generators for generating usable power from flows of water including those such as for example marine currents, tidal or river flows.

### BACKGROUND ART

Underwater power generators are known. However, many present designs include complex mechanisms and parts which have high initial manufacture and deployment costs as well as ongoing reliability problems. These high costs and problems are due in part to the known generators being sensitive to water current flow direction. There are also efficiency and power output problems associated with known designs. Other problems stem from the known generators being sensitive to installation inaccuracies.

The present invention seeks to ameliorate one or more of the abovementioned disadvantages, or at least provide a new power generator.

### DISCLOSURE OF INVENTION

According to a first aspect of the present invention, there is provided an underwater power generation apparatus which includes:

a rotor adapted for rotation about a rotation axis, the rotor comprising a blade assembly including a plurality of blades operatively mounted to the rotor and extending therefrom and adapted to be acted upon by flowing water from a direction generally perpendicular to the rotation axis to rotate the rotor;

wherein the rotor includes an integral rotor body adapted to rotate about a stator body disposed internally relative thereto to generate usable power.

The main body may include a rotor body and a stator body. When a rotor body and a stator body are provided, the rotor body preferably includes suitable electrical windings and/or electro- or permanent magnets of various kinds as may be found on electrical power generating machines and is preferably integral with the rotor body so as to rotate therewith. Where a stator body is provided, it is preferably disposed radially internally relative to the rotor body and also may include any suitable kind of magnet or electrical winding for the purpose of generating electricity.

Permanent magnets may also be incorporated in the rotor body and/or stator body to facilitate electricity generation.

In some arrangements the main body may include a pump mechanism or other kind of power conversion device.

The main body and rotor may be in the form of a cylinder. The integral rotor body may be in the form of a hollow cylinder or annular body or casing; along an external circumferential wall of the hollow cylinder, the blades may be mounted. The main body and rotor are preferably a portion of a pylon, extending upwardly from a sea bed, and sufficiently structurally rigid to support a turbine at a distal end of the cylinder.

The arrangement of blade assemblies may be in any suitable form. For example, there may be a helical blade arrangement of individual blades along and around the circumferential external wall of the cylinder. There also may be any suitable number of blade assemblies and blade sets, including bands or tiers of blades arranged on the circumferential external wall of the casing. There may be any suitable number of bands or tiers, ranging from one to two thousand or more if required. Each tier or band of blades may include any suitable number of blades disposed around the circumference of the cylinder or rotor, and preferably four or six.

The blades may be of any suitable type, having a suitable twist, and cross-sectional foil shape, including bidirectional, however, in a preferred embodiment, the blades are a NACA profile and are monodirectional. In another embodiment, however, the blades are a U-section or V-section or chevron-section, including a catch portion in the form of a concave section and a head, or front portion, in the form of a convex portion. The blades may be tapered along their length.

The bands of blades may be removable either individually or as a band assembly mounted on the circumferential wall. The band assemblies may be arranged in a cartridge arrangement and thus several blades may be removable in a single removal operation with removal of a cartridge assembly.

The blades may be mounted so that the angle of attack may be varied. However, in preferred embodiments the angle of attack is fixed. However, the angle of attack may be varied with position along the length of the rotation axis, to take advantage of variation of direction and speed of incident tidal flows therealong to increase blade efficiency.

The blade assemblies may rotate in any direction, however, in preferred embodiments the blade assemblies rotate the casing only in one direction regardless of direction of tidal flow incident on the blades.

The blades may be of any suitable length, and the length of each blade may be varied with a blades' position along the length of the rotation axis, so as to take advantage of variation of variation of direction and speed of incident tidal flows therealong to increase blade efficiency.

In use the underwater power generation apparatus is preferably mounted on a pylon extending substantially perpendicular, or vertically, from a bed of a body of water so that the rotation axis is substantially perpendicular to the sea bed and also to the flow of ocean currents or tidal flows such as for example in rivers and other bodies of water. However, in some arrangements the apparatus may be mounted horizontally, on arms extending from pylons or pylon assemblies mounted on and extending from the bed. In the latter arrangement the apparatus is preferably mounted substantially perpendicular to the flow of the ocean currents or tidal flows and the like.

Preferably the apparatus includes sufficient structural strength to support a main underwater power generator of a selected kind which may be supported on a remote end of the pylon.

Preferably the stator is mounted on a fixed shaft which extends from both ends of the main body. Preferably the fixed shaft is in turn mounted to legs installed into and extending from a platform. The legs may be extending from and mounted or anchored directly to a sea bed. In these embodiments the fixed shaft is disposed generally horizontally or parallel to the sea bed.

In some arrangements the legs may be of differing lengths so that the fixed shaft is mounted at an acute angle to the sea bed.

In some arrangements the legs may be mounted on a turntable for rotation about a yaw, pitch or even roll axis.

In other arrangements the fixed shaft may be attached to cables or other extensible legs or extensible arrangements so that the main body may be disposed in currents at different depths of the sea or water body.

The main body may include adjustable buoyancy to facilitate access to the various currents at various heights.

The cables may be extended by winches or other take up and deployment apparatus mounted to the sea bed.

According to another aspect of the present invention there is provided an underwater power generation apparatus which includes:

a main body comprising a casing adapted for rotation about a rotation axis, at least one blade assembly including one or more blades operatively mounted to the casing and extending therefrom, the blades in use being disposed in a flow of water from a direction generally perpendicular to the rotation axis, the at least one blade assembly adapted to be acted on by the flowing water from that generally perpendicular direction to generate usable power.

According to still another aspect of the present invention there is provided an underwater power generation apparatus which includes:

a main body comprising a casing adapted for rotation about a rotation axis; a blade assembly including one or more blades operatively mounted to the casing and extending therefrom into a flow of water and adapted to be acted upon by the flowing water to rotate the casing;

a rotor disposed inside the casing and being integral with or connected to the casing for rotation about the rotation axis therewith about a stator also disposed within the casing for generation of usable power.

According to yet another aspect of the present invention there is provided a method of underwater generation of power, the method including:

providing a main body comprising a casing adapted for rotation about a rotation axis; the main body including a blade assembly including one or more blades operatively mounted to the casing and extending therefrom into a flow of water and adapted to be acted upon by the flowing water to rotate the casing; the main body further including a rotor disposed inside the casing and being integral with or connected to the casing for rotation about the rotation axis therewith about a stator also disposed within the casing for generation of usable power;

placing the main body in a body of water so that water flows relative thereto; and

converting rotation energy of the main body into usable power.

According to a yet further aspect of the present invention there is provided a method of generating power underwater, the method including:

providing a main body comprising a casing adapted for rotation about a rotation axis, and providing at least one blade assembly including one or more blades operatively mounted to the casing and extending therefrom, the blades in use being disposed in a flow of water from a direction generally perpendicular to the rotation axis, the at least one blade assembly adapted to be acted on by the flowing water from that generally perpendictilar direction to generate usable power;

placing the main body in a body of water so that water flows relative thereto; and converting the rotation energy of the main body into usable power.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

In order that the present invention may be more clearly understood, preferred embodiments will be described with reference to the following drawings and examples.

### BRIEF DESCRIPTION OF THE DRAWINGS

FIG. 1 is a side elevation view of a power generation apparatus in accordance with a preferred embodiment of the present invention shown installed on a stub mount;

FIG. 2 is a perspective view of a power generation apparatus in accordance with a preferred embodiment of the present invention shown isolated from its mount and other power generation apparatus for clarity;

FIG. 3 is a side section view of the power generation apparatus shown in FIG. 2 having extended main shafts at either end;

FIG. 4 is a side elevation schematic view of the power generation apparatus in accordance with another preferred embodiment of the present invention;

FIG. 5 is a perspective schematic view of yet another preferred embodiment of power generation apparatus;

FIG. 6 is a side elevation schematic view of another mounting arrangement for a preferred embodiment of the present invention; and

FIG. 7 is a side elevation schematic view of still another mounting arrangement for a preferred embodiment of the present invention.

### DETAILED DESCRIPTION OF PREFERRED EMBODIMENTS OF THE INVENTION

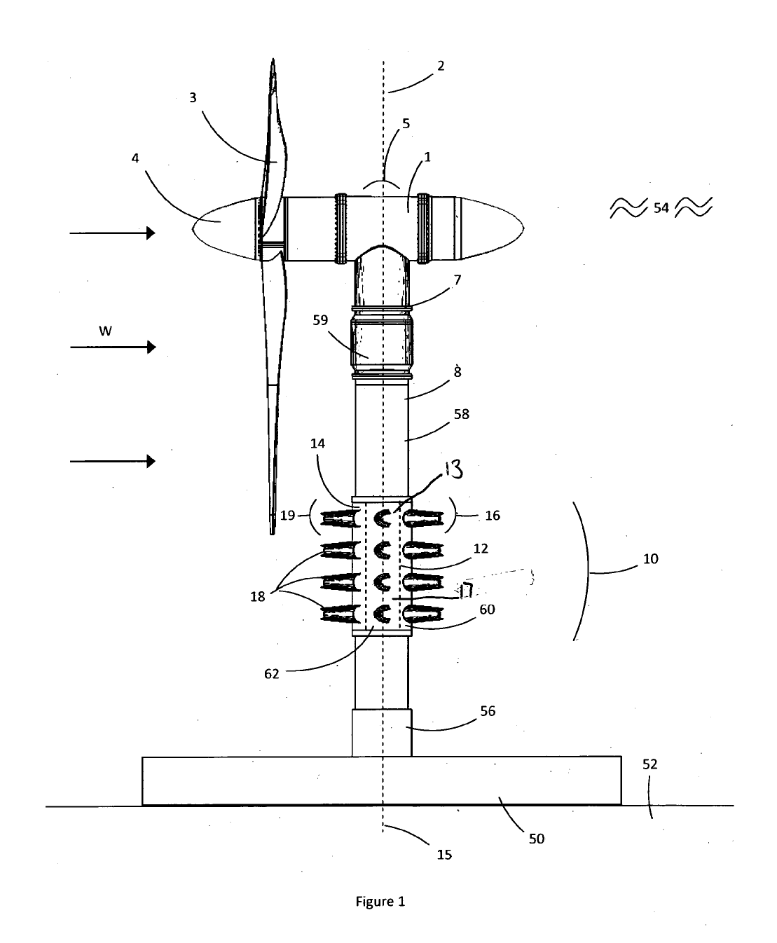

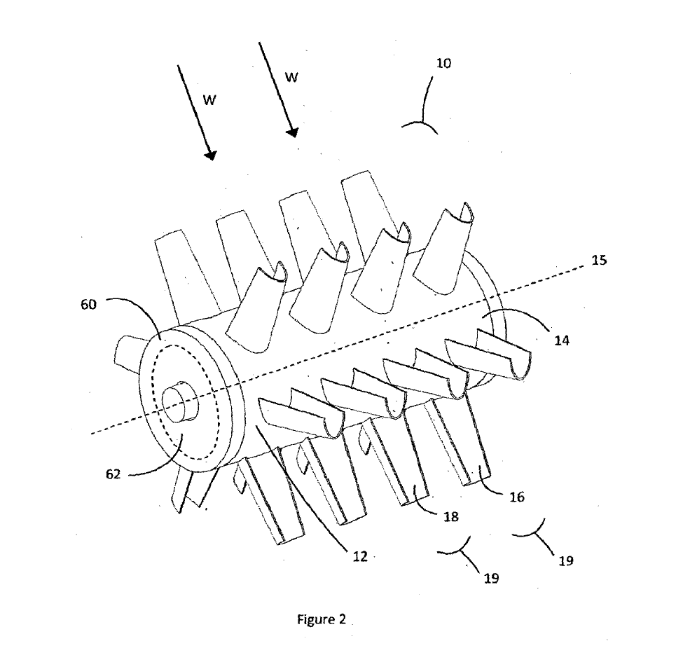

Referring to FIGS. 1 to 3 there is shown a power generator or power generation apparatus generally indicated at 10. The apparatus 10 includes a main body 12 which includes a rotor 13 adapted for rotation about a rotation axis 15, the rotor 13 including an integral rotor body 14 which comprises an annular body or hollow cylinder or casing 17. The main body 12 includes a stator body 62 which is disposed internally relative to the integral rotor body 14.

A blade assembly 16 is provided which includes a plurality of blades 18 operatively mounted on a circumferential external wall of the annual body or hollow cylinder or casing 17 and extending substantially radially therefrom and in use, extending into a body of water. The blades 18 are arranged into tiers or bands 19 and in the embodiments shown in the Figures there are four tiers of blades 18 in the blade assembly 16. In various embodiments there may be provided any suitable number of bands or tiers of blades, and suitable numbers include 2, 4, 6, 8, 10, 12, 15, 20, 25, 30, 40, 50, 75, 100, 150, 200, 500, 750, 1000, 1250, 1500, 2000, or 5000 tiers of blades. Preferably there are provided 12 tiers of blades. Blade cassettes may be placed longitudinally along the axis of the rotor body and may be mounted and removed in longitudinal groups, an arrangement which is not shown but may be appreciated by the person skilled in the art.

The blades 18 shown are all of the same length as one another, that is, between 0.5 m and 1 m long. In some embodiments this length may be extended to about 3 m or more, depending on proximity to other structural elements such as blades 3 of other power generators 5 and also depending on desired efficiency and strength of the blades 18 and overall apparatus 10. In other embodiments the blades 18 may vary in length depending on their disposition along the rotation axis 15 such that, for example, in an embodiment such as that shown in FIG. 1, the top one or two tiers of blades may be shorter than the bottom two tiers of blades, in part due to their proximity to a turbine blade 3, and although the blades are not shown in that Figure as being of varying lengths, they could include that feature. It will be appreciated that due to the concept of shear flow of the water, the incident direction and velocity of marine currents will vary with height from the sea bed, and thus position along the rotation axis 15. Thus, the blade assemblies and blades may be appropriately changed in length, twist, chord length, chord curvature and thickness, attack angle'and other parameters.

The blades 18 may be bidirectional and the pitch may be varied by on board servo motors or other devices (not shown). However, in the preferred embodiment shown the blades 18 are monodirectional, fixed in pitch and all of similar length to one another. The blades 18 shown are U-shaped, V-shaped, or Chevron-shaped, and include a catch portion (shown in the Figures as concave) which drives the rotor and casing in a direction which is clockwise from above in FIG. 1. Advantageously, when the apparatus is mounted generally vertically, the blades 18 are adapted to be acted on by the marine or water current from any horizontal direction and to always rotate in the same direction regardless of direction and speed of incident marine current. If there is no horizontal component of the flow, it will be difficult for the rotor to rotate. When the apparatus is mounted in any orientation, the blades will still rotate the rotor in a selected direction.

The blades 18 include a taper towards their ends and may be swept or raked in a direction counter to the direction of travel to increase blade efficiencys or power.

The main body 12 and/or rotor 13 are structurally suitable to support a supplementary power generator 5 mounted at a distal or remote end 7 of a pylon assembly 8. The supplementary power generator 5 includes a blade set 4 including a plurality of blades 3 rotatably mounted for rotation about a rotation axis 2. A turbine housing 1 is rotatably mounted on the pylon assembly 8 so that it can be adjusted about the rotation axis 2 (which happens in FIG. 1 to coincide with rotation axis 15) to most efficiently capture a changing incident marine current flow W.

It may be that the power generator 10 is a stand alone power generator which is mounted on a sea bed, extending generally or substantially upwards, and the power generated may be transferred by hydraulic pipe or electrical cable to a shoreline storage site or distribution network. In alternative embodiments the power generator 10 may structurally support the supplementary power generating machine 5 as well as supplying hydraulic power and/or services to the supplementary power generator 5, or electrical power to the power generator 5. It is also contemplated that the power generator 5 and the power generator 10 of the present invention and described in detail herein may share the same distribution network.

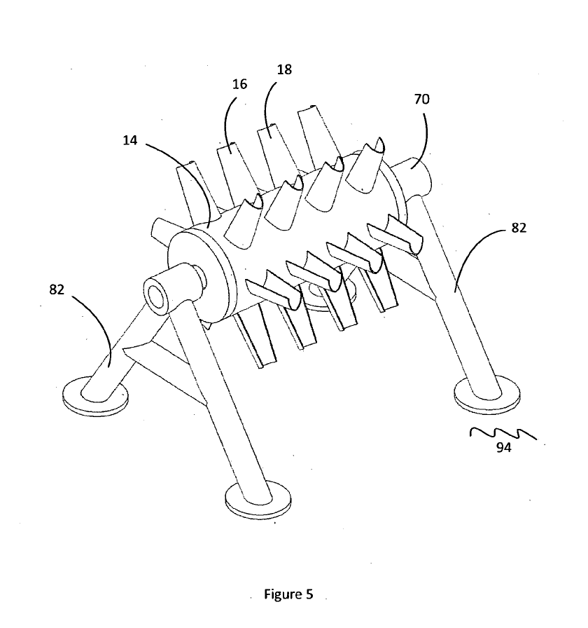

In some arrangements (FIGS. 5-7) the power generator is a standalone device and the main body 12 and rotor 13 may extend horizontally, so as to be perpendicular to the flow of marine current W. In these arrangements the main body or bodies will be mounted on horizontal arms extending from pylon assemblies 8.

Returning to discussion of FIG. 1 and all figures, the main body 12 and rotor 13 include a rotor body 60 and a stator body 62. The stator body 62 is disposed internally relative to the rotor body 60 and integral rotor body 14. The rotor body 60 is mounted against or integral with an interior face of the casing 14 so as to rotate therewith at the same rate as the casing 17 when the casing 17 rotates. The rotor body 60 and the stator body 62 contain electrical windings as is typical of electrical generators and motors and their relative rotation causes the generation of electrical power which can be transported for use or subsequent storage either to a power grid or a storage station.

To install the power generator apparatus 10 a base or pylon base 50 is placed on a bed 52 of a water body 54. A stub or boss 56 may be removably inserted or may be integral with the base 50. The main body 12 is then rotatably mounted on the stub or boss 56. A remote portion 58 of the pylon assembly 8 is then installed on a remote end of the main body 12. The remote portion 58 includes a rotation unit 59 for rotation of the power generator 5. The power generator 5 is then removably mounted on the remote end 7 of the pylon assembly 8. Power from incident currents W may be harnessed and transmitted to a power network for use by consumers or transmitted to storage for later use.

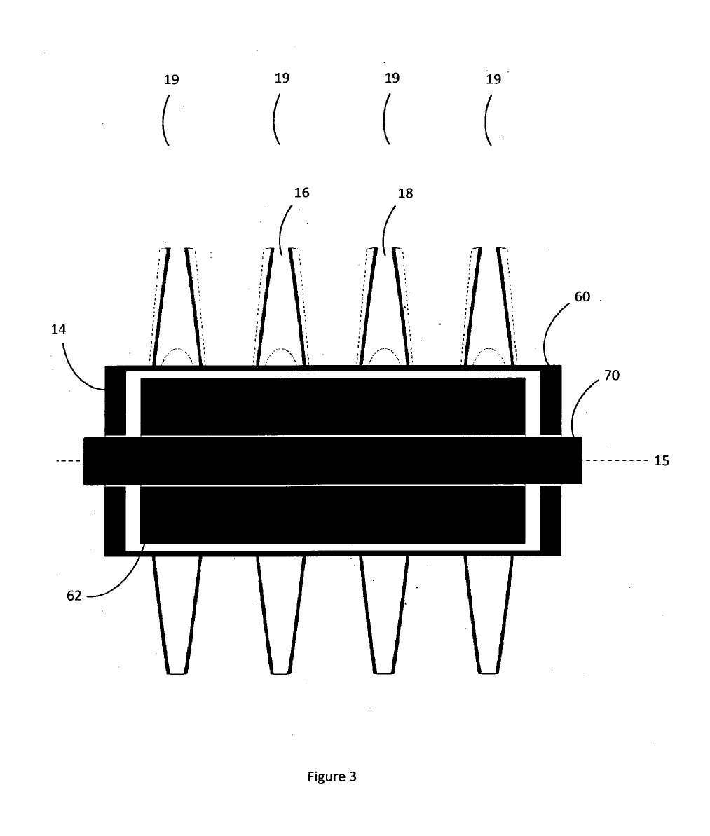

FIG. 3 schematically shows the rotor body windings 60 and fixed stator body windings 62. The rotor 60 is shown as very thin but this Figure is merely schematic shows the general conceptual arrangement of major parts. A fixed shaft 70 which is also fixed to the stator body windings 62 extends from both ends.

In this description portion like numerals associated with parts of one embodiment denote like parts of another embodiment unless otherwise indicated.

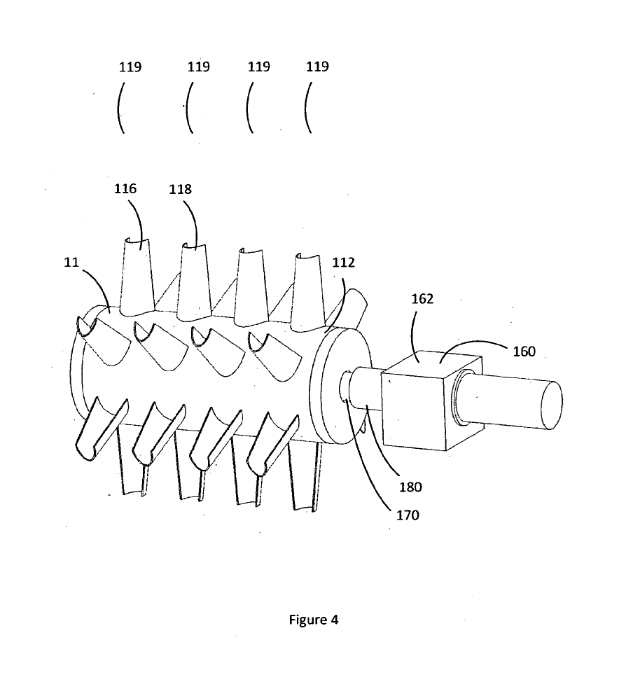

FIG. 4 is a schematic arrangement of another preferred embodiment which shows a conventional generator 180 disposed adjacent the main body 112 having a rotor body 160 and a stator body 162 in a conventional arrangement (rotor inside the stator) driven by a shaft 170.

FIG. 5 shows the power generation apparatus of FIG. 3 which has the fixed shafts 70 mounted on legs or arms 82. The legs or arms are mounted into a sea-bed mounted platform (not shown) or mounted directly onto a sea bed 94.

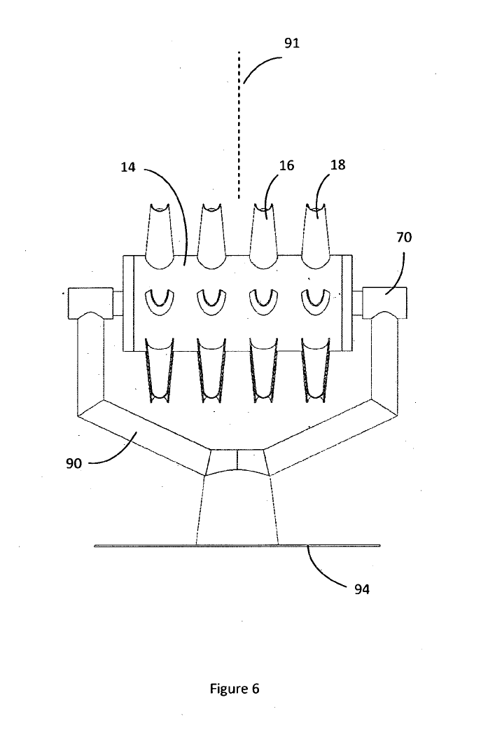

FIG. 6 shows the power generation apparatus of FIG. 3 having the fixed shafts 70 mounted on a turntable apparatus 90 so that the main body 12 and rotor 13 can rotate about a yaw axis 91. Rotation may be effected about other axes including roll or pitch.

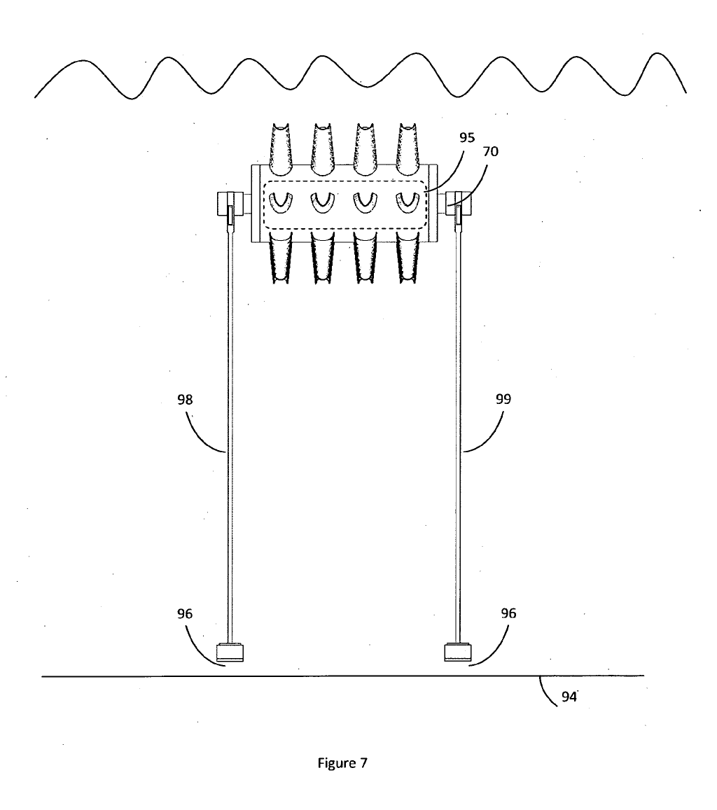

FIG. 7 shows the power generation apparatus of FIG. 3 including buoyancy chambers 95 and a mounting apparatus which includes cables 98 and 99 attached to fixed main shafts 97. Winches 96 mounted on the sea bed 94 in use extend so that the main body 12 and rotor 13 may, under the influence of the (in some embodiments variable) buoyancy in the chambers 95, elevate to access currents of varying strengths at various depths above the sea bed 94. The legs and arms and cables may be extensible, of different lengths or of variable lengths to adjust the attitude of the rotor body from angled or horizontal to vertical.

A monitoring and control system (not shown) may be provided so as to monitor various parameters of the environment and generator performance so as to indicate the. most efficient height for the main body 12 and rotor 13.

A brake may be provided so that blades may be protected from over fast current.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An underwater power generation apparatus which includes:
an axle extending in use perpendicular to a flowing water direction;
an electrical generator including a stator body disposed on the axle, the stator body comprising electrical windings;
a rotor rotatably mounted on the axle, the rotor comprising a hollow body including a rotor wall and including magnets or electromagnets integral therewith, the rotor disposed for rotation about the stator for generation of electricity; and
a blade assembly including a plurality of blades operatively mounted to the outer wall of the rotor and extending generally radially therefrom, the blades being spaced apart from one another along the rotor wall in an axial direction as well as being spaced apart from one another around the rotor wall in a circumferential direction, the blades being adapted to be acted upon by the flowing water from the flowing water direction.

2.-5. (canceled)

6. The underwater power generation apparatus of claim 1, wherein the axle is a pylon which extends from a pylon base mounted on a sea bed.

7. The underwater power generation apparatus of claim 1, wherein the axle supports a supplementary power generator disposed at a distal or head end of the rotor body.

8. The underwater power generation apparatus of claim 1, wherein the blade assembly is in the form of a plurality of bands or tiers of blades arranged on the circumferential external wall of the rotor body.

9. The underwater power generation apparatus of claim 8 wherein there are provided between about two and two thousand bands or tiers of blades.

10. The underwater power generation apparatus of claim 9 wherein there are provided between about four and twelve bands or tiers of blades.

11. The underwater power generation apparatus of claim 1, wherein the blades are a U-section or V-section or chevron-section and include a catch portion in the form of a concave section and a head, or front portion, in the form of a convex portion.

12. The underwater power generation apparatus of claim 1, wherein the blades are tapered such that they have a smaller cross section at their tip than at their root.

13. The underwater power generation apparatus of claim 8, wherein the bands of blades are removable.

14. The underwater power generation apparatus of claim 13, wherein the blades are removable in an arrangement such as a cartridge arrangement and thus several blades may be removable in a single removal operation with removal of a cartridge assembly.

15. The underwater power generation apparatus of claim 1, wherein the angle of attack and/or length of blades is varied with position along the length of the rotor to take advantage of variation of direction and speed of incident tidal flows therealong to increase blade efficiency and/or power output.

16-19. (canceled)

20. The underwater power generation apparatus of claim 1, wherein the rotor body includes adjustable buoyancy to facilitate access to differing currents at various heights.

21. (canceled)

22. The underwater power generation apparatus of claim 1, wherein the rotor body is in the form of a hollow cylinder.

23. The underwater power generation apparatus of claim 1, wherein the axle is mounted generally horizontally, on one or more arms or cables extending from mounts on the sea bed.

24. The underwater power generation apparatus of claim 23, wherein the arms or cables may be of differing lengths so that the fixed shaft is mounted at an acute angle to the sea bed.

25. The underwater power generation apparatus of claim 23, wherein the arms or cables are mounted on a turntable or other device for rotation about a yaw, pitch or roll axis.

26. The underwater power generation apparatus of claim 23, wherein the cables or arms may be extensible or extended so that the main body may be disposed in currents at different depths of the sea or water body.

27. The underwater power generation apparatus of claim 23, wherein the cables may be extended by winches or other take up and deployment apparatus mounted to the sea bed
